(19) United States
(12) Patent Application Publication
(10) Pub. No.: US 2012/0000024 A1
(43) Pub. Date: Jan. 5, 2012

(54) AUTOMATED CAMERA CLEANING SYSTEM

(75) Inventor: Jacob Kyle Layton, Tucson, AZ (US)

(73) Assignee: RAYTHEON COMPANY, Waltham, MA (US)

(21) Appl. No.: 12/827,262

(22) Filed: Jun. 30, 2010

(51) Int. Cl. B08B 7/00

(52) U.S. Cl. 15/97.1; 15/3

(57) ABSTRACT

Embodiments of an automated camera cleaning system are provided. In one embodiment, the automated camera cleaning system includes an optical path, an optically-transmissive lens shield through which the optical path extends, a housing in which the optically-transmissive lens shield is at least partially disposed, and a motor coupled to the lens shield. When energized, the motor moves the optically-transmissive lens shield relative to the housing to vary the region of the optically-transmissive lens shield positioned in the optical path.

### TECHNICAL FIELD

The following disclosure relates generally to autonomous camera systems and, more particularly, to embodiments of an automated camera cleaning system well-suited for deployment onboard a remotely-operated robot or vehicle.

### BACKGROUND

Video cameras and other optical imaging devices are often deployed onboard remotely-controlled vehicles, robots, and the like to provide streaming video feeds to one or more remotely-stationed operators. For example, commercial passenger vehicles utilized during military targeting maneuvers (commonly referred to as “high speed moving targets”) are commonly retrofitted with at least one video camera, a wireless transceiver, and other specialized equipment, which enable remotely-stationed personnel to operate the vehicle in a desired manner High speed moving targets are often operated in flat, dry areas (e.g., dried lake beds or desert terrains), which tend to release large amounts of dust and other debris into the air as the ground is disturbed by movement of the moving targets and by detonation of munitions. The airborne debris may accumulate over the camera lens, obstruct the camera's forward-looking field-of-view, and thereby interfere with remote-operation of the high speed moving target. Operation of the high speed moving targets may consequently be halted, and manual cleaning of the camera lens may be required before targeting maneuvers can be resumed. Manual cleaning of a camera deployed onboard a high speed moving target can be a cumbersome and time-consuming process, which may require that a technician or other personnel member depart from a safe zone, travel several miles to the location at which the high speed vehicles are being operated, manually clean the camera lens, and then again travel several miles to return to the safe zone. Similar inconveniences are also entailed in the manual cleaning of cameras deployed onboard other remotely-operated vehicles and robots including, for example, Unmanned Airborne Vehicles included within Unmanned Aircraft Systems.

One widely-known automated camera cleaning system, commonly utilized in conjunction with traffic photo-enforcement cameras, includes a housing containing a camera; a transparent panel, which provides a line-of-sight through the housing; a wiper blade, which is pivotally mounted to the exterior of the housing adjacent the transparent panel; and a motor, which intermittently moves the wiper blade across the outer surface of the transparent panel to clear away dust, water, and other substances that accumulate thereon. While generally satisfactory for usage in conjunction with stationary photo-enforcement cameras, such externally-mounted wiper systems are generally unsuitable for deployment onboard remotely-controlled vehicles and robots of the type described above. As the wiper blade clears debris from the outer surface of the transparent pane, the wiper blade temporarily obstructs the camera's field-of-view. When the camera is utilized to provide a remotely-located operator with a nearly instantaneous or “real-time” video feed, temporary obstruction of the camera's field-of-view can be distracting to the remote operator and may be unacceptable in certain mission scenarios. Furthermore, externally-mounted wiper systems of the type described above only intermittently clear away debris deposited over the camera lens. As a result, conventional wiper systems may not clear away debris with sufficient efficiency in scenarios wherein a large amount of debris is suddenly deposited over the camera lens due to, for example, a neighboring detonation. While the frequency with which the wiper blade sweeps across the transparent panel can be increased, this results in a corresponding increase in the frequency with the wiper blade obstructs the camera's field-of-view.

It is thus desirable to provide embodiments of an automated camera cleaning system that continually removes debris deposited over a camera lens without obstructing the camera's field-of-view. It would also be desirable if, in certain embodiments, the automated camera cleaning system deterred or prevented the accumulation of ice and/or water over the camera lens. Lastly, it would be desirable for such an automated camera cleaning system to be relatively rugged and to operate reliably in relatively harsh operating conditions characterized by, for example, prolonged sun exposure or freezing temperatures. Other desirable features and characteristics of the present invention will become apparent from the subsequent Detailed Description and the appended Claims, taken in conjunction with the accompanying Drawings and this Background.

### BRIEF SUMMARY

Embodiments of an automated camera cleaning system are provided. In one embodiment, the automated camera cleaning system includes an optical path, an optically-transmissive lens shield through which the optical path extends, a housing in which the optically-transmissive lens shield is at least partially disposed, and a motor coupled to the lens shield. When energized, the motor moves the optically-transmissive lens shield relative to the housing to vary the region of the optically-transmissive lens shield positioned in the optical path.

### BRIEF DESCRIPTION OF THE DRAWINGS

At least one example of the present invention will hereinafter be described in conjunction with the following figures, wherein like numerals denote like elements, and:

FIGS. 1, 2, 3, and 4 are isometric, side, front exploded, and rear exploded views, respectively, of an automated camera cleaning system in accordance with an exemplary embodiment of the present invention.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. As appearing herein, the term “camera” is utilized in a broad sense to denote any optical sensor that detects radiation within the visible, infra-red, or other band of the electromagnetic spectrum including, but not limited to, daytime and nighttime video cameras, synthetic aperture radar sensors, and infrared (e.g., thermographic) cameras.

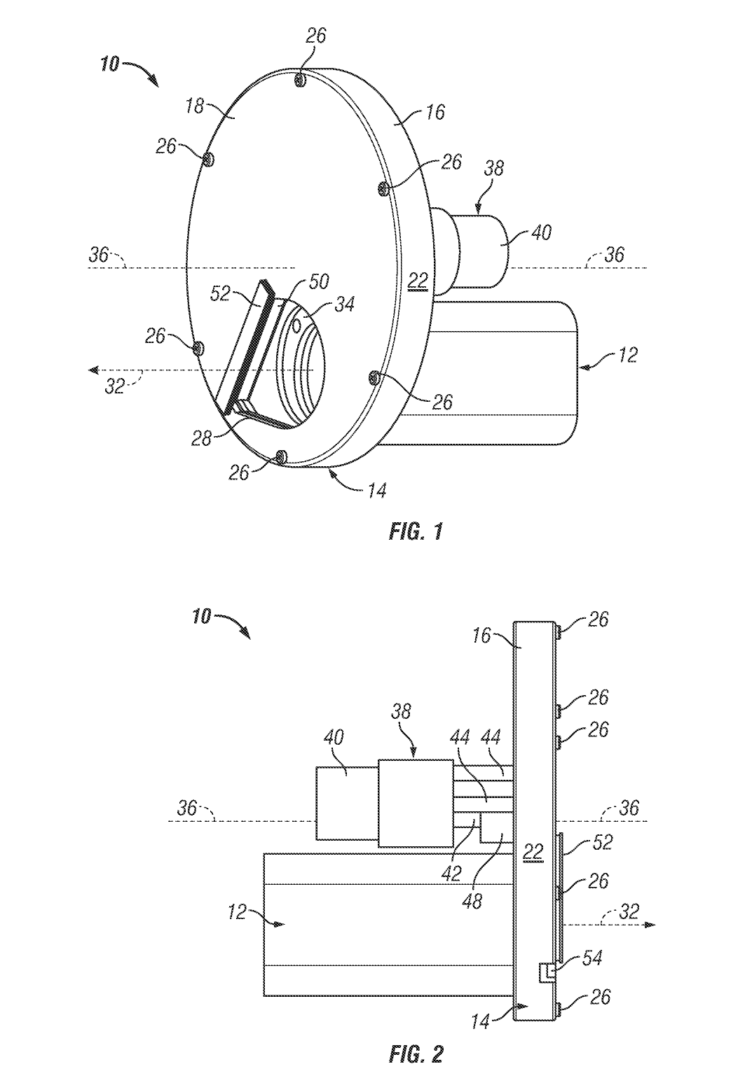

FIGS. 1 and 2 are isometric and side views, respectively, of an automated camera cleaning system 10 in accordance with an exemplary embodiment. As will be explained more fully below, automated camera cleaning system 10 continually removes dust and other debris that accumulates over the lens of a camera without obstructing the camera's field-of-view. Embodiments of automated camera cleaning system 10 also prevent the build-up of ice and remove condensation from over the camera lens or, more specifically, from a protective lens shield positioned over the camera lens. As a still further advantage, automated camera cleaning system 10 is relatively rugged and can operate reliably in harsh operating conditions characterized by, for example, prolonged sun exposure or freezing temperatures. Considering these attributes, automated camera cleaning system 10 is well-suited for deployment onboard a remotely-operated robot or vehicle, such as an Unmanned Aerial Vehicle or a high speed moving target of the type described. In addition, embodiments of automated camera cleaning system 10 may be useful for deployment within operating environments wherein large amounts of dust or other particulate matter is airborne and tends to accumulate over the lens of a camera. For example, embodiments of cleaning system 10 may be especially useful for deployment onboard military convoys to provide streaming video feeds to increase situational awareness of a surrounding area; for deployment in stationary camera assemblies exposed to rain, snow, sunlight, and other weather conditions; and for deployment in stationary camera assemblies utilized to monitor machining or other manufacturing operations that tend to release large amounts of sawdust, metal particles, or other debris into the surrounding air. This notwithstanding, embodiments of automated camera cleaning system 10 are scalable and can be utilized within a wide variety of different platforms and operating environments.

Automated camera cleaning system 10 includes, or is configured to be utilized in conjunction with, at least one camera. For example, as indicated in FIGS. 1 and 2, automated camera cleaning system 10 may include a single camera 12, such as a daytime or nighttime video camera, which may be mounted to a lens shield housing 14 included within automated camera cleaning system 10. In embodiments wherein automated camera cleaning system 10 includes at least one dedicated camera, such as video camera 12, the housing of the camera or cameras can be integrally formed with lens shield housing 14 to yield a single, relatively lightweight, and relatively rugged unit. Conversely, in embodiments wherein cleaning system 10 is not packaged with at least one dedicated camera, automated camera cleaning system 10 may be configured to enable any one of a number of different commercially-available cameras to be mounted to lens shield housing 14 utilizing, for example, a universal mounting bracket or similar mounting means. In this manner, a user can first purchase automated camera cleaning system 10, select a desired “off-the-shelf” camera, and then mount the selected camera to cleaning system 10 for subsequent usage.

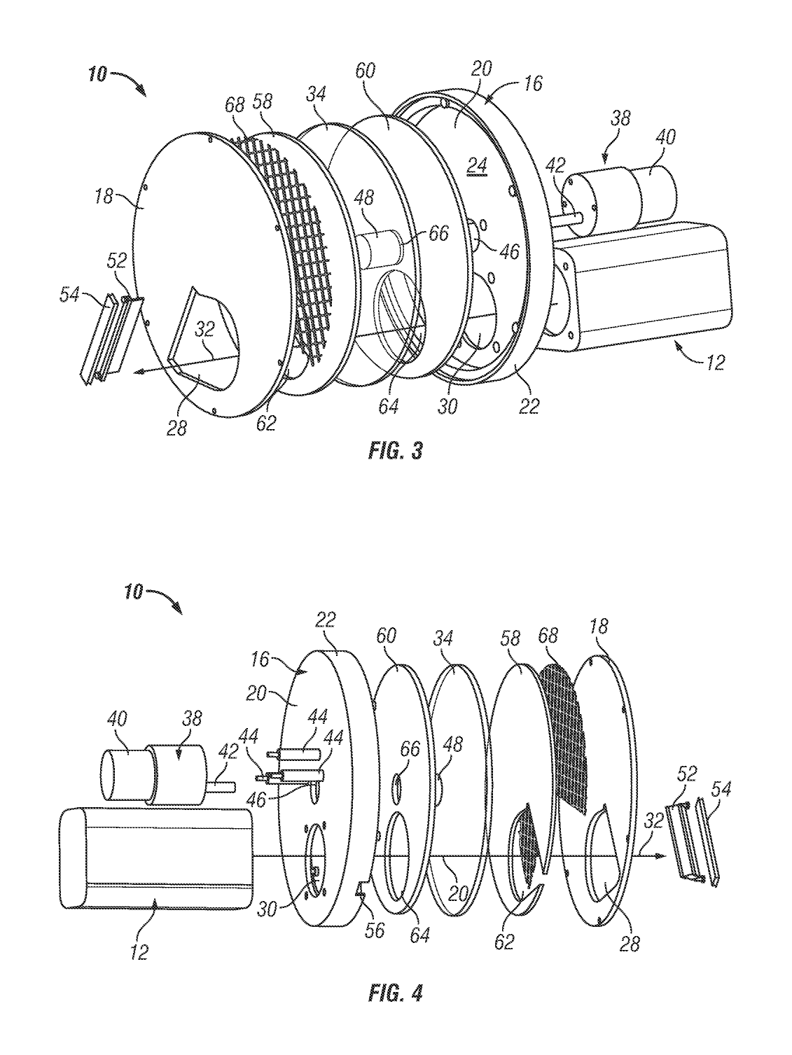

FIGS. 3 and 4 are front and rear exploded views, respectively, of automated camera cleaning system 10. In the exemplary embodiment illustrated in FIGS. 1-4, lens shield housing 14 includes two primary components, namely, a main housing member 16 and a cover piece 18. Main housing member 16 assumes the form of a relatively shallow cylindrical body having a generally circular back wall 20 (shown in FIGS. 3 and 4); an annular sidewall 22, which extends around an outer circumference of circular back wall 20; and a generally cylindrical cavity 24 (shown in FIG. 3). Cover piece 18 has a generically circular geometry and is joined to annular sidewall 22 of main housing member 16 to enclose cavity 24. As indicated in FIGS. 1 and 2, cover piece 18 can be attached to annular sidewall 22 of main housing member 16 utilizing a plurality of bolts 26 or other such fasteners. Main housing member 16 and cover piece 18 are each conveniently formed from a relatively lightweight metal or alloy, such as aluminum. The foregoing notwithstanding, the number of components included within lens shield housing 14, the shape and dimensions of the components included within housing 14, the material or materials from which the components of housing 14 are produced, and the manner in which the components of housing 14 are joined will inevitably vary amongst different embodiments.

A front aperture 28 (shown in FIGS. 1, 3, and 4) is provided through cover piece 18, and a rear aperture 30 (shown in FIGS. 3 and 4) is provided through back wall 20 of main housing member 16. When automated camera cleaning system 10 is assembled, front aperture 28 and rear aperture 30 align, as taken along the longitudinal axis of lens shield housing 14, to partially define an optical path 32 through lens shield housing 14. When camera 12 is mounted to back wall 20 of main housing member 16 in the above-described manner, optical path 32 provides camera 12 with a line-of-sight through lens shield housing 14. As shown most clearly in FIGS. 3 and 4, automated camera cleaning system 10 further includes an optically-transmissive lens shield 34 through which optical path 32 extends. Optically-transmissive lens shield 34 is disposed within cavity 24 of lens shield housing 14 and is configured to rotate within housing 14 about a rotational axis (represented in FIGS. 1 and 2 by dashed line 36). In the illustrated example, optically-transmissive lens shield 34 assumes the form of a disc or sheet of a non-opaque material, such as glass or plastic (e.g., Plexiglas®). However, the geometric shape of optically-transmissive lens shield 34, the dimensions of lens shield 34, and the material or material from which lens shield 34 is formed may vary amongst different embodiments.

Automated camera cleaning system 10 is further equipped with a drive motor 38 having a motor casing 40 and a rotatable shaft 42. Motor casing 40 is conveniently mounted to lens shield housing 14 adjacent and, perhaps, substantially parallel to camera 12; e.g., as indicated in FIGS. 2 and 4, motor casing 40 may be mounted to a plurality of mounting pins 44, which project from a central portion of back wall 20 of main housing member 16. In alternative embodiments, motor casing 40 may be integrally formed with main housing member 16. When automated camera cleaning system 10 is assembled, shaft 42 of motor 38 connects to a spindle 48, which extends through a central opening 46 provided in back wall 20 of main housing member 16 to engage a central portion of optically-transmissive lens shield 34. As a result of this structural arrangement, motor 38, when energized, will rotate optically-transmissive lens shield 34 about its rotational axis (again, represented in FIGS. 1 and 2 by dashed line 36) to continually vary the region of lens shield 34 positioned in optical path 32. In the illustrated exemplary embodiment, and with reference to the orientation shown in FIGS. 1 and 3, motor 38 is configured to rotate optically-transmissive lens shield 34 in a clockwise direction. Although the speed at which motor 38 rotates lens shield 34 during operation of cleaning system 10 will undoubtedly vary, motor 38 will typically rotate lens shield 34 at a relatively slow rotational speed, such as one revolution per minute.

At least one wiper blade 50 is mounted to optically-transmissive lens shield housing 14 and positioned to sweep across a face of lens shield 34 as lens shield 34 rotates relative to lens shield housing 14. In the illustrated example, specifically, a single wiper blade 50 is mounted to an inner edge of cover piece 18 partially defining front aperture 28 utilizing, for example, a mounting bracket 52. Wiper blade 50 is thus positioned within front aperture 28 to sweep across the front face of optically-transmissive lens shield 34 (specifically, across an outer annular band of the lens shield) as lens shield 34 rotates. It will be noted that wiper blade 50 is positioned outside of optical path 32 and, therefore, outside of the field-of-view of camera 12. Thus, as lens shield 34 is rotated by motor 38, dust and other debris that has accumulated on the region of lens shield 34 exposed through front aperture 28 is moved into contact with and collects against wiper blade 50. As it collects against wiper blade 50, the debris moves downward due to gravitational forces and is ultimately ejected from automated camera cleaning system 10 through a debris chute 54 provided in main housing member 16; e.g., a notch-shaped cut-out formed in annular sidewall 22, as shown in FIGS. 2 and 4. As may be most easily appreciated in FIGS. 1 and 4, wiper blade 50 may also be angled to move the debris toward debris chute 54 as the debris aggregates against blade 50. Movement of aggregated debris toward debris chute 54 may also be promoted by ram airflow in embodiments wherein automated camera system 10 is deployed aboard a forward moving vehicle or robot, such as a high speed moving target. Wiper blade 50, motor 38, and lens shield 34 thus cooperate to continually remove debris from optical path 32 and thereby prevent the accumulation of debris over the lens of camera 12 without obstructing the field-of-view of camera 12. Due to the disposition of wiper blade 50 within front aperture 28, and the manner in which wiper blade 50 is partially drawn into cavity 24 of lens shield housing 14 during clockwise rotation of lens shield 34, wiper blade 50 is largely shielded from direct sun exposure and is consequently less sensitive to drying and cracking than is, for example, the wiper blade of a conventional externally-mounted camera wiper system.

Although automated camera cleaning system 10 is shown in FIGS. 1-4 and is primarily described herein as including a single wiper blade 50 positioned to remove debris from an outer surface of a given region of optically-transmissive lens shield 34 immediately after the region rotates through optical path 32, cleaning system 10 may include any number of wiper blades assuming other dispositions in further embodiments. For example, in another embodiment, an additional wiper blade can be positioned to sweep across the inner surface of optically-transmissive lens shield 34 to remove debris or condensation therefrom. Additionally or alternatively, one or more wiper blades can be positioned to sweep across a given region of optically-transmissive lens shield 34 immediately prior to rotation of the given region into optical path 32.

It is preferred, although by no means necessary, that automated camera cleaning system 10 further includes at least one cleaning member. In the illustrated exemplary embodiment, and with specific reference to FIGS. 3 and 4, automated camera cleaning system 10 further includes a front cleaning pad 58 and a rear cleaning pad 60. Front cleaning pad 58 and rear cleaning pad 60 include a first optical path opening 62 and a second optical path opening 64, respectively, which align with front aperture 28 and rear aperture 30 when automated camera cleaning system 10 is assembled to define optical path 32 and thereby provide camera 12 with a line-of-sight through housing 14. Rear cleaning pad 60 also includes a central opening 66 through which spindle 48 extends. As indicated in FIGS. 3 and 4, cleaning pads 58 and 60 may each have a circular geometry and an outer diameter substantially equivalent to the outer diameter of optically-transmissive lens shield 34; however, the shape and dimensions of the cleaning pads included within automated camera cleaning system 10, if any, will vary amongst different embodiments. When automated camera cleaning system 10 is assembled, optically-transmissive lens shield 34 resides between front cleaning pad 58 and rear cleaning pad 60, which contact the front and rear faces of lens shield 34, respectively. As lens shield 34 is rotated about longitudinal axis 36 (FIGS. 1 and 2) by motor 38, cleaning pads 58 and 60 sweep across the opposing faces of optically-transmissive lens shield 34 to remove any dust or other debris that was not removed by wiper blade 50 and/or to polish lens shield 34. In addition, in embodiments wherein cleaning pads 58 and 60 are formed from an absorbent material, such as a felt, wool, or micro-fiber, cleaning pads 58 and 60 may remove moisture (e.g., rain, snow, condensation, etc.) from the major faces of lens shield 34.

In embodiments wherein cleaning system 10 is exposed to freezing temperatures, and considering wind chill in cases wherein cleaning system 10 is deployed onboard a high speed moving target or other rapidly moving object, automated camera cleaning system 10 is preferably further equipped with at least one heating element that, when energized, heats optically-transmissive lens shield 34 to minimize or prevent the formation of ice thereon. For example, as indicated in FIGS. 3 and 4, automated camera cleaning system 10 may include a waffle-shaped heating element 68 disposed adjacent cleaning pad 58 substantially opposite the leading face of optically-transmissive lens shield 34. When energized, heating element 68 heats lens shield 34 through front cleaning pad 58 to prevent icing of the leading face of lens shield 34 exposed to ambient airflow through front aperture 28. In further embodiments, heating element 68 or a similar heating element may be embedded within cleaning pad 58 and/or cleaning pad 60.

The foregoing has thus provided at least one exemplary embodiment of an automated camera cleaning system that continually removes debris deposited over a camera lens, or more specifically over a protective lens shield, without obstructing the camera's field-of-view. The above-described exemplary automated camera cleaning system also minimizes or prevents ice build-up over the camera lens and/or removes water (e.g., rain, snow, condensation, etc.) from over the camera lens. Due to its ruggedized construction and ability operate reliably in relatively harsh operating conditions, the above-described exemplary cleaning system is well-suited for deployment onboard remotely-operated robots and vehicles, such as high speed moving targets. As a still further advantage, the above-described exemplary automated camera cleaning system is highly manufacturable and relatively inexpensive to produce due, at least in part, to its lack of control circuitry and ability to incorporate commercially-available cameras.

Although, in the above-described exemplary embodiment, the optically-transmissive lens shield assumed the form of a non-opaque disc configured to rotate in a plane substantially orthogonal to the optical path and the longitudinal axis of a camera, the optically-transmissive lens shield may assume other forms and may be moved in various other manners in further embodiments of the automated camera cleaning system. For example, the optically-transmissive lens shield can assume the form of a ring that circumscribes a camera and that is rotated by a motor about an axis substantially orthogonal to the longitudinal axis of the camera. In further embodiments, the optically-transmissive lens shield may have a spherical, hemispherical, or relatively flat polygonal geometry and may undergo rotational or oscillatory movement during operation of the automated camera cleaning system.

While described above in conjunction with a single camera (i.e., camera 12 shown in FIGS. 1-4), embodiments of the automated camera cleaning system can easily be adapted for use in conjunction with multiple camera systems (e.g., two or more optical paths can be provided through lens shield housing 14 shown in FIGS. 1 and 2) including stereoscopic camera assemblies. Similarly, alternative embodiments of automated camera cleaning system may include additional structural components other than those explicitly set-forth above. Other components that may usefully be included within alternative embodiments of the automated camera cleaning system include, but are not limited to, environmental seals (e.g., one or more gaskets or O-rings), integrated power supplies (e.g., one or more batteries), and wireless transmitters suitable for transmitting the video data or other optical data provided by the camera associated with the automated camera cleaning system.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. An automated camera cleaning system, comprising:
an optical path;
an optically-transmissive lens shield through which the optical path extends;
a housing in which the optically-transmissive lens shield is at least partially disposed; and
a motor coupled to the optically-transmissive lens shield and, when energized, configured to move the optically-transmissive lens shield relative to the housing to vary the region of the optically-transmissive lens shield positioned in the optical path.

2. An automated camera cleaning system according to claim 1 wherein the optical path extends through the housing.

3. An automated camera cleaning system according to claim 1 wherein the motor is configured to continually rotate the optically-transmissive lens shield about a rotational axis, when the motor is energized.

4. An automated camera cleaning system according to claim 3 wherein the rotational axis and the optical path are substantially parallel.

5. An automated camera cleaning system according to claim 1 wherein the optically-transmissive lens shield comprises a disc.

6. An automated camera cleaning system according to claim 5 wherein the housing comprises a substantially cylindrical cavity in which the disc is rotatably mounted.

7. An automated camera cleaning system according to claim 1 further comprising a wiper blade coupled to the housing and configured to wipe across the optically-transmissive lens shield to remove debris therefrom as the optically-transmissive lens shield is moved relative to the housing.

8. An automated camera cleaning system according to claim 7 wherein the housing comprises a front aperture and a rear aperture substantially aligned with the front aperture, as taken along the longitudinal axis of the housing, the optical path extending through the front aperture and through the rear aperture.

9. An automated camera cleaning system according to claim 8 further comprising a camera coupled to the housing over the rear aperture.

10. An automated camera cleaning system according to claim 9 wherein the camera is positioned adjacent and is substantially parallel to the motor.

11. An automated camera cleaning system according to claim 8 wherein the wiper blade is at least partially disposed within the front aperture.

12. An automated camera cleaning system according to claim 8 further comprising a debris chute formed through the housing proximate the front aperture.

13. An automated camera cleaning system according to claim 1 further comprising a first cleaning pad disposed within the housing and contacting a first face of the optically-transmissive lens shield.

14. An automated camera cleaning system according to claim 13 further comprising a second cleaning pad disposed within the housing and contacting a second, opposing face of the optically-transmissive lens shield.

15. An automated camera cleaning system according to claim 13 wherein the optical path extends through an opening provided in the first cleaning pad.

16. An automated camera cleaning system according to claim 1 further comprising a heating element disposed within the housing and, when energized, configured to heat the optically-transmissive lens shield.

17. An automated camera cleaning system, comprising:
a housing having an optical path therethrough;
an optically-transmissive lens shield positioned through the optical path and mounted within the housing for rotation about a rotational axis substantially parallel with the optical path;
a motor coupled to the optically-transmissive lens shield and, when energized, configured to rotate the optically-transmissive lens shield relative to the housing to continually vary the region of the optically-transmissive lens shield positioned in the optical path; and
a wiper blade coupled to the housing and configured to sweep across the optically-transmissive lens shield to remove debris therefrom as the optically-transmissive lens shield rotates relative to the housing.

18. An automated camera cleaning system according to claim 17 wherein the automated camera cleaning system comprises a camera mounted to the housing, and wherein the optically-transmissive lens shield comprises a disc configured to rotate in plane substantially orthogonal to the longitudinal axis of the camera.

19. An automated camera cleaning system, comprising:
a housing having a front aperture, a rear aperture, and a cavity;
a camera mounted to the housing over the rear aperture and having a line-of-sight extending through the rear aperture, the front aperture, and the cavity;
an optically-transmissive lens shield rotatably mounted within the housing between the front aperture and the rear aperture; and
a motor coupled to the optically-transmissive lens shield and, when energized, configured to rotate the optically-transmissive lens shield relative to the housing to continually vary the region of the optically-transmissive lens shield positioned between the front aperture and the rear aperture.

20. An automated camera cleaning system according to claim 19 further comprising:
a heating element disposed within the housing and configured to heat the optically-transmissive lens shield when energized; and
a cleaning pad disposed within the housing between the heating element and the optically-transmissive lens shield, the cleaning pad contacting the leading face of the optically-transmissive lens shield.
